(19) United States
(12) Patent Application Publication
(10) Pub. No.: US 2013/0332426 A1
(43) Pub. Date: Dec. 12, 2013

(54) INFORMATION PROCESSING APPARATUS AND INFORMATION PROCESSING METHOD

(71) Applicant: KABUSHIKI KAISHA TOSHIBA, TOKYO (JP)

(72) Inventor: Tsuyoshi NISHIDA, Tokyo (JP)

(73) Assignee: KABUSHIKI KAISHA TOSHIBA, TOKYO (JP)

(21) Appl. No.: 13/867,779

(22) Filed: Apr. 22, 2013

(30) Foreign Application Priority Data
Jun. 12, 2012 (JP) 2012-133129

(51) Int. Cl. G06F 17/30

(52) U.S. Cl. CPC G06F 17/30303
USPC 707/690

(57) ABSTRACT

According to one embodiment, an information processing apparatus includes a nonvolatile memory, a calculation module and a storage module. The nonvolatile memory has a data region as a subject of falsification detection and a hash value storage region in which a hash value of the data region is written. The calculation module calculates the hash value from the data. The storage module stores the calculated hash value in the hash value storage region. According to another embodiment, an information processing method includes: providing a nonvolatile memory which has a data region as a subject of falsification detection and a hash value storage region in which a hash value of the data region is written; calculating the hash value from the data; and storing the calculated hash value in the hash value storage region.

### CROSS-REFERENCE TO RELATED APPLICATION(S)

This application is based upon and claims the benefit of priority from Japanese Patent Application No. 2012-133129, filed Jun. 12, 2012; the entire contents of which are incorporated herein by reference.

### FIELD

Embodiments described herein relate generally to an information processing apparatus and an information processing method for speeding up detection of alteration/falsification of a nonvolatile memory.

### BACKGROUND

There are techniques which enable falsification/alternation detection for a nonvolatile memory.

### BRIEF DESCRIPTION OF THE DRAWINGS

FIG. 1 is a perspective view showing an example of schematic configuration of a personal computer as an information processing apparatus according to an embodiment.

FIG. 2 is a system configuration diagram showing this embodiment.

FIG. 3 is a schematic operation view of this embodiment.

FIG. 4 is a flow chart showing an example of alternation/falsification detection in this embodiment.

FIG. 5 is an explanatory view showing trust chain used in this embodiment.

FIG. 6 is a diagram showing an example of hardware configuration of an information processing apparatus according to an embodiment.

### DETAILED DESCRIPTION

According to one embodiment, an information processing apparatus includes a nonvolatile memory, a calculation module and a storage module. The nonvolatile memory has a data region as a subject of falsification detection and a hash value storage region in which a hash value of the data region is written. The calculation module calculates the hash value from the data. The storage module stores the calculated hash value in the hash value storage region.

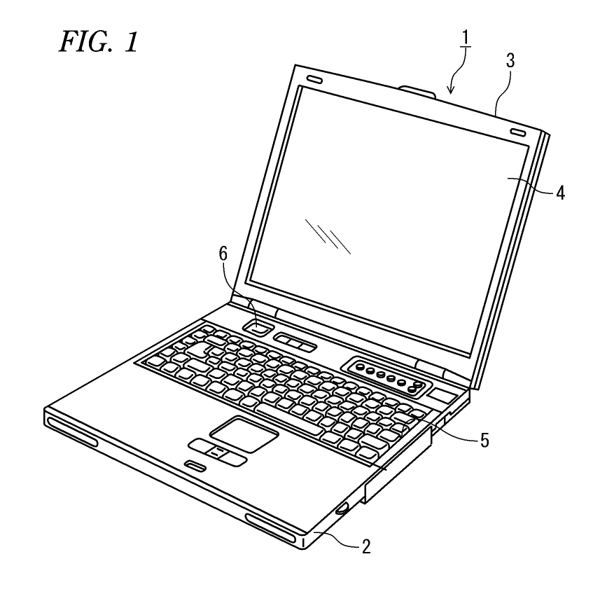

Various embodiments will be described hereinafter with reference to the accompanying drawings of FIGS. 1 to 6.

FIG. 1 is a view showing the external appearance of a notebook type personal computer as a representative example of an information processing apparatus 1 according to a first embodiment of the invention.

The information processing apparatus 1 has an information processing apparatus body 2 and a panel portion 3 which form a thin rectangular shape. The information processing apparatus body 2 and the panel portion 3 are formed so as to be desirably opened/closed through hinge portions.

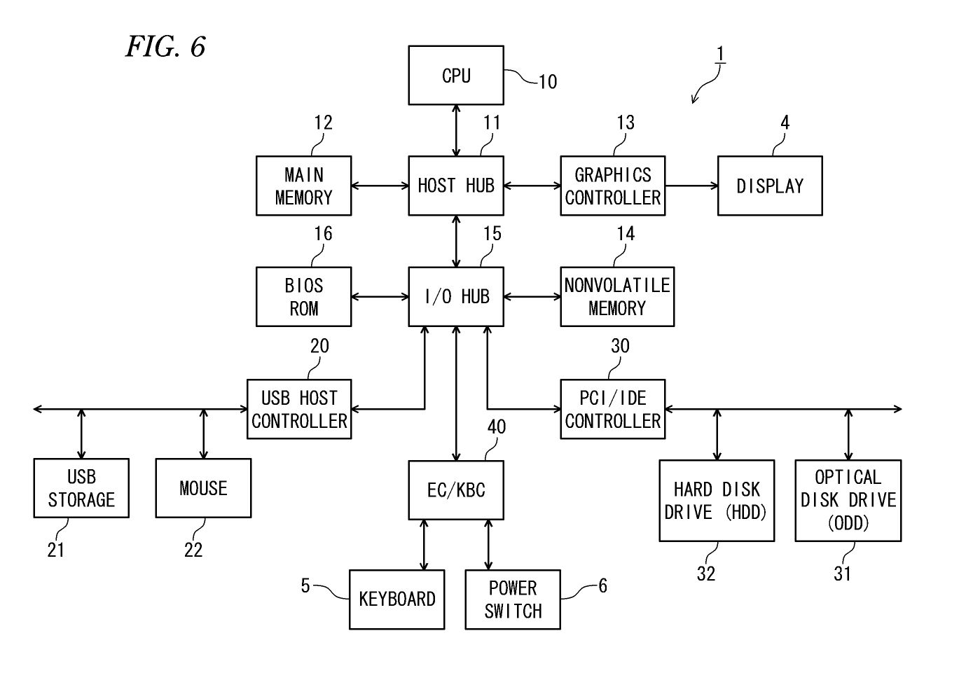

A keyboard 5 for performing various kinds of operations of the information processing apparatus 1 in addition to inputting of various kinds of data, a power switch 6 for powering on/off the information processing apparatus 1, etc. are provided in an upper surface of a housing of the information processing apparatus body 2. A system board in which electronic components (see FIG. 6) such as a CPU 10 and a main memory 12 are mounted, and external storage devices such as a CD/DVD drive (optical disk drive) 31 and a hard disk drive 32 are built in the information processing apparatus body 2. In addition, USB devices such as a USB storage 21 can be connected to the information processing apparatus body 2.

The panel portion 3 has a display 4 which is provided in an opening portion inside the panel portion 3 and on which various kinds of information and images are displayed. FIG. 6 is a block diagram showing an example of hardware configuration of the information processing apparatus 1. The information processing apparatus 1 has a CPU 10 for controlling the whole system. The CPU 10 exchanges data with various kinds of internal constituent components through a host hub 11 and an I/O hub 15.

The internal constituent components provided in the information processing apparatus 1 include a main memory 12 which stores programs and data temporarily and serves as a work area for the CPU 10, a BIOS ROM 16 which stores a BIOS, and a nonvolatile memory 14 which stores required data.

In addition, a USB host controller 20 which controls various kinds of USB devices and a PCI/IDE controller 30 which controls PCI devices and IDE devices are connected to the I/O hub 15. A USB storage 21 having a built-in flash memory or the like, a mouse 22, etc. are connected to the USB host controller 20. On the other hand, an optical disk drive 31 which reads/writes data from/into an optical disk such as a CD or a DVD, and a hard disk drive (HDD) 32 are connected to the PCI/IDE controller 30.

An EC/KBC (Embedded Controller/KeyBoard Controller) 40 as an embedded processor is also connected to the I/O hub 15. A keyboard 5 and a power switch 6 are further connected to the EC/KBC 40.

Incidentally, the USB host controller 20 and the PCI/IDE controller 30 may be provided as internal constituent components of the I/O hub 15.

A BIOS 100 which is system firmware, and an OS (Operating System) 200 are provided as software in the information processing apparatus 1.

The BIOS 100 is software which is installed as firmware in the information processing apparatus 1 and which starts up first when the information processing apparatus 1 is activated. The BIOS 100 is stored in the BIOS ROM 16 in such a manner that the BIOS 100 cannot be uninstalled by ordinary operation. The BIOS 100 is read from the BIOS ROM 16 and executed by the CPU 10.

On the other hand, the OS 200 is stored together with various kinds of application software in a magnetic disk in the HDD 32 and booted by the BIOS 100. After booted, the OS 200 is executed by the CPU 10. The OS 200 includes various kinds of utility software (hereinafter simply referred to as utilities), and driver software (hereinafter simply referred to as drivers) for controlling various kinds of devices.

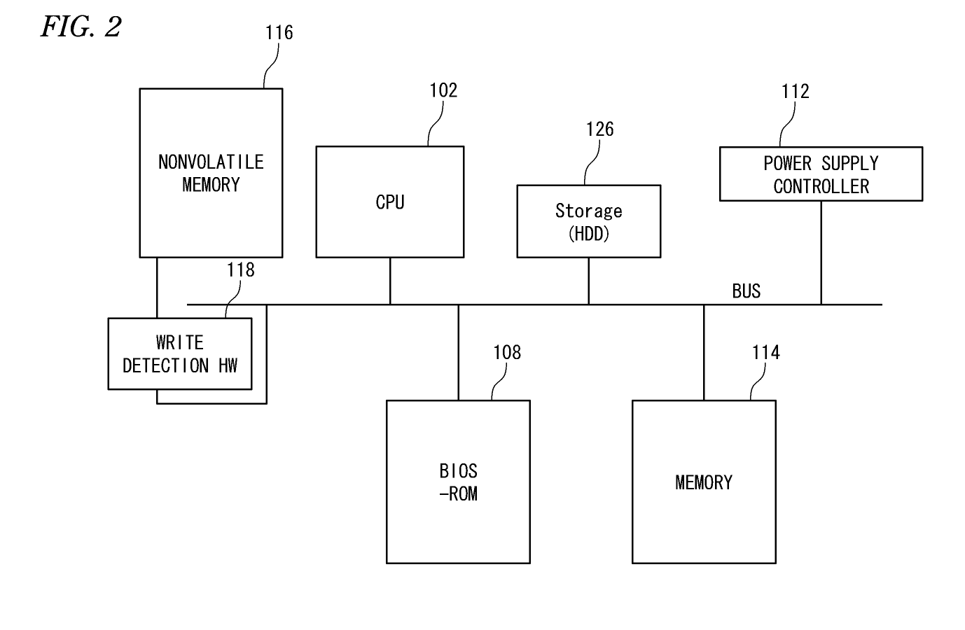

An example of system configuration of this computer (relevant function of the information processing apparatus 1) will be described below with reference to a functional block diagram shown in FIG. 2.

This computer has a CPU 102, a BIOS-ROM 108 as a first storage device, an RAM 14 as a main memory (second storage device), a nonvolatile memory 116 (including a controller which is not shown but will be described later), a hard disk drive (HDD) 126, etc. The CPU 102 is a processor which is provided for controlling the operation of this computer and which executes an operating system (OS) and various kinds of application programs loaded from the hard disk drive (HDD) 126 to the main memory 114.

The CPU 102 is equivalent to the CPU 10. The BIOS-ROM 108 is equivalent to the BIOS ROM 16. The RAM 114 as the main memory is equivalent to the main memory 12. The nonvolatile memory 116 is equivalent to the nonvolatile memory 14. The hard disk drive (HDD) 126 is equivalent to the hard disk drive (HDD) 32.

In addition to the CPU 102, the memory 114 and the nonvolatile memory 116, a power supply controller 112, etc. are connected onto a BUS of this computer. The BUS is expressive of functional (virtual) connection. Actually, the BUS includes the host hub 11 and the I/O hub 15 in accordance with constituent components.

At the time of system boot, configuration is made so that the CPU 102 loads a program on a storage to the memory 114 and executes the program. At the time of powering off, the CPU 102 controls the power supply controller 112 to power off the system. At the time of powering off, the memory 114 can hold contents of the memory. For example, the BIOS-ROM 108 inputs an address, a size and a hash value on the nonvolatile memory 116 relevant to the OS or each application operating on the memory 114 and outputs a hash value. The nonvolatile memory 116 may serve also as the BIOS-ROM 108.

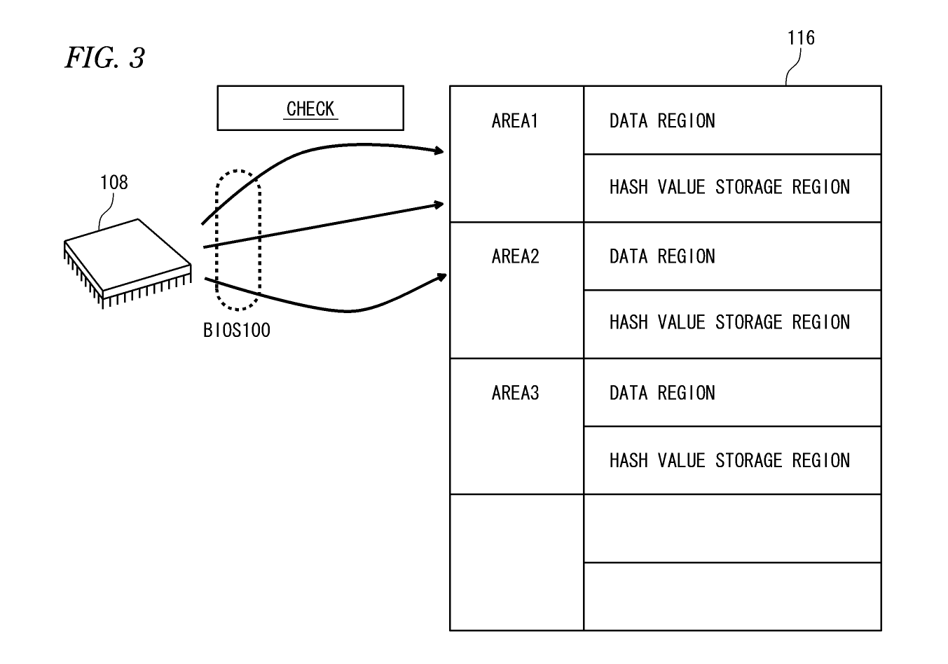

FIG. 3 shows the relationship between the BIOS-ROM 108 and the nonvolatile memory 116. In this embodiment, for example, software is separated into three parts, that is, OS, application 1 and application 2. The memory region (region as a subject of falsification detection) to be used for software is separated physically. The CPU 102 sends the address and size of each split memory region as an input value to the BIOS-ROM 108, operates the BIOS 100 to detect falsification of the nonvolatile memory 116 and receives the hash value of the memory region (from the write monitoring target range) as an output.

When the nonvolatile memory 116 is separated into a plurality of areas (e.g. Area1, Area2, Area3, . . . ) so that each area is used as a subject of alteration/falsification detection, data (or code) as a subject of alteration/falsification detection is stored, for example, in a data region of Area1 in the nonvolatile memory 116. The same rule is also applied to Area2 et seq.

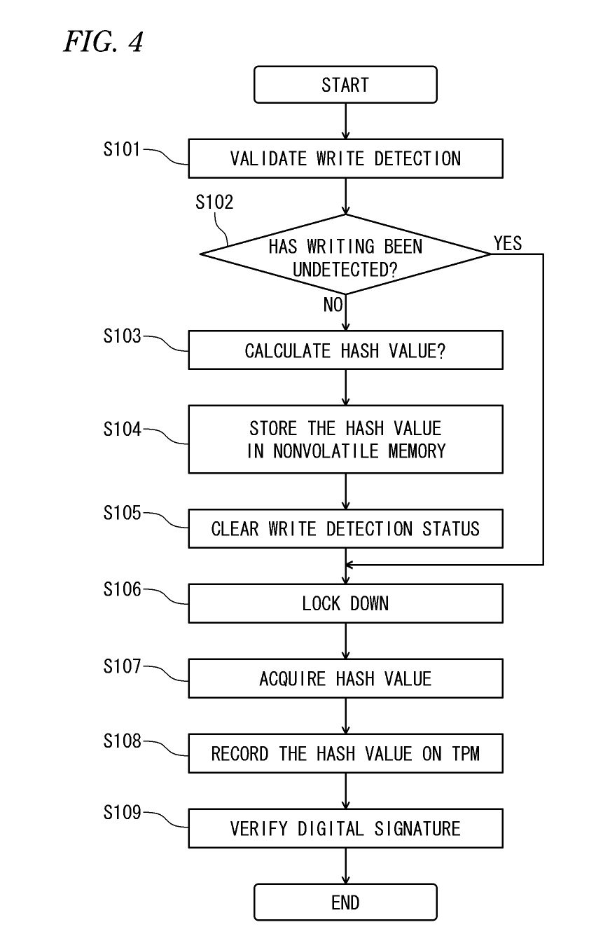

FIG. 4 is a flow chart of processing performed by the BIOS-ROM 108 and showing an example of alteration/falsification detection in this embodiment. A method of detecting alteration/falsification of the nonvolatile memory will be described with reference to FIG. 4. Incidentally, portions indicated in gray in FIG. 4 show existing processes (existing techniques).

First, hardware (new) for detecting writing in the nonvolatile memory is prepared. The write detection hardware 118 has a “write detection status” showing a write detection range (a start address, an end address, etc.) and detection of writing. The write detection status takes one of three states, that is, indeterminate state, write detected state, and write undetected state. The write detection status is nonvolatile and, for example, held by a battery. The initial value of the write detection status is an indeterminate state. When the aforementioned battery is shut off, the write detection status returns to an indeterminate state. Step S101: Make the controller of the nonvolatile memory 116 set the write detection range (a start address, an end address, etc.) and validate write detection performed by the controller. That is, the whole Areal (i.e. data region+hash value storage region) of the nonvolatile memory 116 is set as a subject of write detection.

In this manner, both writing in the data region of Areal and writing in the hash value storage region of Areal can be detected (both falsification of the data region and storage of a value different from the hash value of the data region in the hash value storage region can be monitored (detected) simultaneously).

Step S102: Read the write detection status and check whether the write detection status is a write undetected state or not. When the write detection status is a write undetected state, the flow of processing goes to step S106. Otherwise (when the write detection status is an indeterminate state or a write detected state), the flow of processing goes to step S103.

Step S103: Calculate the hash value of the nonvolatile memory 116 included in the write detection range. When a plurality of hash algorithms (e.g. SHA (Secure Hash Algorithm)-1® and SHA-256®) are used, respective hash values may be calculated. For example, the hash value of the data region of Areal in the nonvolatile memory 116 is calculated.

Step 104: Store the hash value calculated by the step S103, for example, in the hash value storage region of Areal in the nonvolatile memory 116. On this occasion, the write detection status turns to a write detected state. When there are a plurality of targets of hash calculation in the write detection range, the steps S103 and S104 may be executed a plurality of times.

Step S105: Clear the write detection status (set the write detection status as a write undetected state).

Step S106: Lock down hardware concerned with write detection. That is, forbid changing the write detection range and clearing the write detection status. The lockdown is continued until the controller of the nonvolatile memory is reset (it is important that the write detection status is nonvolatile and still held even if the controller of the nonvolatile memory is reset).

Step S107: Read the hash value stored by the step S104.

Step S108: Record (Extend) the hash value (e.g. SHA-1®) onto TPM (Trusted Platform Module)®. This process may be executed if necessary.

Step S109: Verify a digital signature by using the hash value (e.g. SHA-256®). This process may be executed if necessary.

Incidentally, when there are plural of targets of alteration/falsification detection in the write detection range, the steps S107 to S109 may be executed a plurality of times.

Among the aforementioned processes, the step S108, etc. will be complemented here. First, TPM® is a security chip whose use has been standardized by TCG (Trusted Computing Group).

To record integrity of software, regions called Platform Configuration Registers (PCRs) are provided in the security chip. The PCRs can be reset only at the time of powering on. Data can be written in the PCRs only by a special instruction called “Extend”.

In “Extend”, an operation of PCR=HASH (PCR+Digest) as generalized expression is performed on the registers. Accordingly, a convoluted value of the hash value recorded since the start-up time is PCR, so that it is difficult to handle the PCR value as an arbitrary value. This is a basic mechanism using TPM for recording and protecting integrity of software.

16 or 24 PCRs are provided so that allocation of the PCRs in BIOS and virtualization is determined by TCG. PCR8(PCR(8)) and PCRs after PCR8(PCR(8)) are allocated to “flexible use”. Respective devices and files are measured at start-up time. For example, SHA1(SHA-1) digest is recorded on PCRs of TPM® by “Extend”. That is, PCR(i)=SHA1(PCR(i)+Digest). TPM® and CRTM which will be described later are located in hash hold HW 110.

As needs in the aforementioned processing, needs for security have been increasing day by day in the PC trade under the pressure of the necessity of starting up the system while verifying a digital signature. On the other hand, there are needs of starting up the PC rapidly, so that it is necessary to speed up the digital signature verification. The invention is under needs of safely caching the hash value required in the process of digital signature verification.

In view of cost, by appealing to chipset vendors, write detection hardware of the nonvolatile memory is mounted. It is supposed that there will be little cost increase. (Appendix to Embodiment: Function)
(1) The hash value of each region as a subject of falsification detection among regions of the nonvolatile memory is stored in the write monitoring target range of this region.
(2) In a write undetected state, the hash value of each region as a subject of falsification detection is acquired from the nonvolatile memory (directly without calculation). The hash value is used for alteration/falsification detection etc. of the nonvolatile memory.
(3) This system is a system which has a function of detecting writing in the nonvolatile memory. On this occasion, the write monitoring target range can be designated.
(4) This system is a system in which the write detection status is held in the nonvolatile memory.
(5) This system is a system in which the write detection status can be cleared (overwritten as a write undetected state). Clearing the write detection status can be forbidden so that lockdown can be set in this state (a lock state can be held until next Power On Reset).

As an effect of the embodiment, the time required for calculating the hash value (for the nonvolatile memory) can be saved (starting can be speeded up) while security such as Chain Of Trust and digital signature verification is achieved.

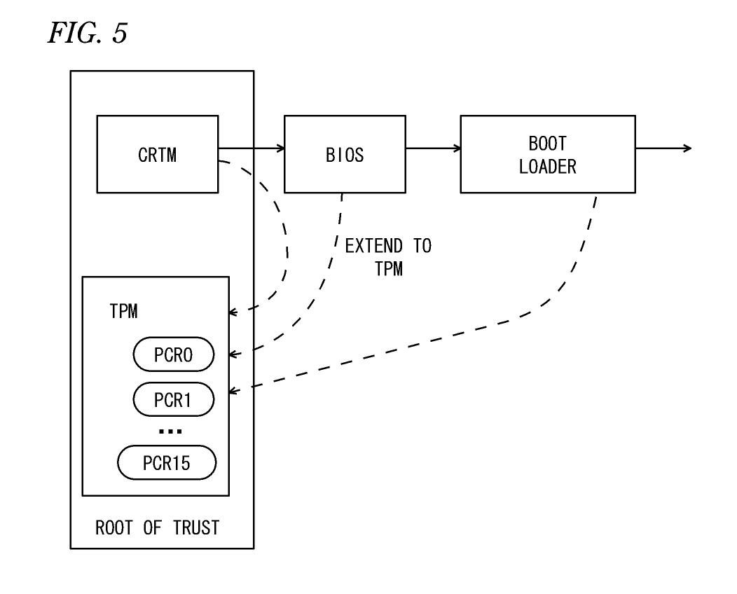

FIG. 5 is an explanatory view showing trust chain (Chain Of Trust) used in the embodiment.

A method of recording information of software integrity on TPM is called Trusted Boot. An initial start code is called Core Root Of Trust Measurement (CRTM) and protected physically as a part of Root of Trust.

CRTM performs measurement of itself and next start BIOS code and recording thereof on TPM® and shifts control to BIOS. When the steps of starting up after measuring codes and recording them on TPM® in this manner are repeated, Chain Of Trust started at CRTM can be applied on the whole software. As a result, reliability originating in hardware can be given to software. For use of Trusted Boot in Linux (registered trademark) operating on PC, it is first necessary that BIOS is based on the TCG (Trusted Computing Group) specification.

Incidentally, the invention is not limited to the aforementioned embodiment but various modifications may be made on the invention without departing from the gist of the invention.

A plurality of constituent elements disclosed in the aforementioned embodiment may be combined suitably to form various inventions. For example, some constituent elements may be removed from all constituent elements disclosed in one embodiment. In addition, constituent elements disclosed in different embodiments may be combined suitably.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus that detects falsification/alteration of data stored to a nonvolatile memory, the apparatus comprising:
a nonvolatile memory comprising a data region and a hash value storage region; and
a processor configured to:
calculate a hash value for data of the data region, the hash value enabling detection of falsification/alteration of the data, and
store the calculated hash value to the hash value storage region.

2. The information processing apparatus of claim 1, wherein the processor is further configured to:
detect writing to the data region or the hash value storage region; and
in response to not detecting writing, acquire the hash value from the nonvolatile memory.

3. The information processing apparatus of claim 2, wherein the processor is further configured to detect alteration/falsification of the data using the hash value.

4. The information processing apparatus of claim 1, wherein the processor is further configured to detect writing to the nonvolatile memory.

5. The information processing apparatus of claim 2, wherein the processor is further configured to store to a write detection status to the nonvolatile memory or read the write detection status from the nonvolatile memory.

6. The information processing apparatus of claim 2, wherein the processor is further configured to clear a write detection status.

7. An information processing method for detecting falsification/alteration of data stored to a nonvolatile memory, the method comprising:
calculating a hash value for data of a data region of a nonvolatile memory, the hash value enabling detection of falsification/alteration of the data, the nonvolatile memory comprising the data region and a hash value storage region; and
storing the calculated hash value to the hash value storage region.
